(19) United States
(12) Patent Application Publication
(10) Pub. No.: US 2026/0233286 A1
(43) Pub. Date: Aug. 13, 2026

(54) SINTERING ASSEMBLIES AND ASSOCIATED COMPONENTS AND METHODS

(71) Applicant: Battelle Energy Alliance, LLC, Idaho Falls, ID (US)

(72) Inventors: Arin S. Preston, Idaho Falls, ID (US); Jorgen F. Rufner, Idaho Falls, ID (US)

(21) Appl. No.: 19/537,384

(22) Filed: Feb. 11, 2026

Related U.S. Application Data
(60) Provisional application No. 63/757,640, filed on Feb. 12, 2025.

(51) Int. Cl. B21D 28/34; B21D 37/14; B29C 43/32; B29C 43/36

(52) U.S. Cl. CPC B21D 28/34; B21D 37/14; B29C 2043/3255; B29C 2043/3618

(57) ABSTRACT

A sintering assembly includes a mold defining a cavity. The sintering assembly further includes at least one ram configured to extend into the cavity. The sintering assembly also includes a negative punch disposed in the cavity and a positive punch disposed in the cavity. The positive punch includes at least two segments, each segment of the at least two segments comprising a ram interface configured to abut against the at least one ram. Related methods and sintering punches are also disclosed.

### CROSS-REFERENCE TO RELATED APPLICATIONS

This application claims the benefit under 35 U.S.C. § 119(e) of U.S. Provisional Patent Application Ser. No. 63/757,640, filed Feb. 12, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Sintering assemblies are disclosed. More specifically, sintering assemblies, components and methods are disclosed for sintering complex geometries of structures.

### BACKGROUND

Sintering is a process where a structure is formed by applying high pressures and temperatures to a powdered material in a mold. The high temperature is selected to sinter particles of the powdered material together without reaching a melting temperature of the powdered material. After a period of time, a solid part is formed from the sintered powder material. The resulting material of the sintered structure is conventionally a material having high hardness, such as ceramics, hard metals, and or synthetic diamond materials. The sintering temperatures may be in a range from about 700° C. to about 2000° C. depending on the material being sintered.

### SUMMARY

Embodiments of the disclosure include a sintering assembly. The sintering assembly includes a mold defining a cavity. The sintering assembly further includes at least one ram configured to extend into the cavity. The sintering assembly also includes a negative punch disposed in the cavity. The sintering assembly further includes a positive punch disposed in the cavity, the positive punch comprising at least two segments, each segment of the at least two segments comprising a ram interface configured to abut against the at least one ram.

Another embodiment of the disclosure includes a method. The method includes disposing a first punch into a cavity of a mold, the first punch comprising one or more segments. The method further includes depositing a base material over the first punch in the cavity of the mold. The method also includes disposing a second punch over the base material in the cavity of the mold, the second punch comprising one or more segments. The method further includes applying a pressure to the base material between the first punch and the second punch. The method also includes applying heat to the base material between the first punch and the second punch until the base material forms a solid structure. The method also includes removing the first punch from the solid structure by separating one segment of the first punch from another segment of the first punch. The method further includes removing the second punch from the solid structure by separating a first segment of the second punch from a second segment of the second punch.

Other embodiments of the disclosure include a sintering punch. The sintering punch includes a base. The sintering punch further includes a semispherical surface on an opposite axial end of the sintering punch from the base. The sintering punch also includes an intermediate segment forming an intermediate portion of the base and an intermediate portion of the semispherical surface. The sintering punch further includes at least two outer segments forming outer portions of the base and outer portions of the semispherical surface, the intermediate segment configured to be removed axially relative to the at least two outer segments. The sintering punch also includes an interface between the intermediate segment and at least one of the at least two outer segments, the interface angled such that the intermediate segment has a first width at the base that is greater than a second width of the intermediate segment at the semispherical surface

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a sintering assembly in accordance with embodiments of the disclosure;

FIG. 2A illustrates a perspective view of a positive punch of the sintering assembly of FIG. 1;

FIGS. 2B and 2C illustrate cross-sectional views of the positive punch of FIG. 2A;

FIG. 3 illustrates a schematic view of an outer segment of the positive punch of FIGS. 2A-2C;

FIG. 4A illustrates a top down view of an inner segment of the positive punch of FIGS. 2A-2C;

FIG. 4B illustrates a perspective view of the inner segment of the positive punch of FIGS. 2A-2C;

FIG. 4C illustrates a front view of the inner segment of the positive punch of FIGS. 2A-2C;

FIG. 4D illustrates a side view of the inner segment of the positive punch of FIGS. 2A-2C;

FIG. 5 illustrates an exploded view of a negative punch of the sintering assembly of FIG. 1;

FIG. 6 illustrates a schematic view of a sintering assembly in accordance with embodiments of the disclosure; and

FIG. 7 illustrates a flow chart representative of a method of sintering a structure in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, an orientation, and an arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “above,” “upper,” “top,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal,” “longitudinal,” or “lateral” direction is a direction that is substantially parallel to the major plane of the structure, while a “vertical” direction is a direction that is substantially perpendicular to the major plane of the structure. The major plane of the structure is defined by a surface of the structure having a relatively large area compared to other surfaces of the structure. For example, the “horizontal,” “longitudinal,” and “lateral” directions are substantially parallel with one or more of the X-axis and the Y-axis. The “vertical” direction is substantially parallel with the Z-axis.

As discussed above, sintering is a process where a structure (e.g., an article) is formed by applying high pressures and high temperatures to a powdered material in a mold. Structures having complex geometries, such as negative space where a mold protrudes into the structure to form a cavity, may be more difficult to form. For example, removing the mold from the structure after the structure is held at high temperatures and pressures may be more difficult. Conventionally, structures having complex geometries are sintered using single use molds that are destroyed or damaged to remove the mold from the final sintered structure. Forming a mold in a manner that the mold may be disassembled after sintering the structure may facilitate reusable molds for sintering more complex geometries of the structures.

As used herein, the term “complex geometry,” refers to and includes a three-dimensional shape that is difficult to form by powder compaction and sintering in a closed mold because the resulting sintered structure cannot be readily withdrawn from a monolithic punch or die without damage to the punch, the mold, or the sintered structure. Non-limiting examples of complex geometries include: re-entrant or undercut features (e.g., a lip, hook, or reverse taper) that mechanically lock the sintered structure to the punch and prevent axial withdrawal; internal cavities or enclosed voids (e.g., hollow regions, blind internal chambers, or pocketed volumes) that use a punch feature to occupy the void during sintering and thereby create interference upon removal; and/or non-axisymmetric or multi-lobed profiles (e.g., asymmetric bosses, saddle shapes, or multi-peak surfaces) that constrain withdrawal directions and can induce nonuniform compaction, shrinkage, and interface bonding, thereby increasing the likelihood of tool seizure and fracture during demolding.

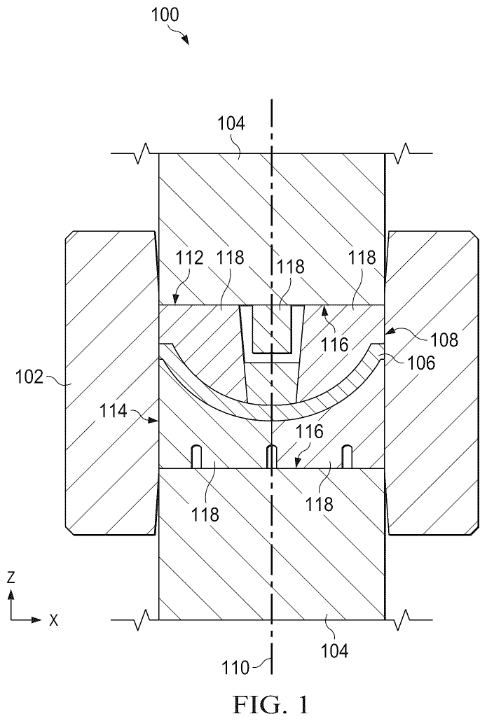

FIG. 1 illustrates a sintering assembly 100 that may be used to form a structure through a sintering process. The sintering assembly 100 may be configured to heat a base material 106 while applying a pressure to the base material 106 to form a solid structure. In some embodiments, the sintering assembly 100 is an electric field assist sintering (EFAS) assembly configured to apply a pressure to the base material 106 while heating the material and sintering assembly 100 by passing an electric current through the sintering assembly 100 and the base material 106. In other embodiments, the sintering assembly 100 may be a hot press sintering assembly where the sintering assembly 100 is heated externally, such as through inductive heating, resistance heating, etc.

The sintering assembly 100 includes a mold 102 defining a cavity 108 within the mold 102 configured to receive the base material 106 to be sintered. The sintering assembly 100 also includes one or more rams 104 configured to apply an axial pressure to the base material 106 in the cavity 108 of the mold 102 along an axis 110. In the embodiment illustrated in FIG. 1 sintering assembly 100, the sintering assembly 100 includes two opposing rams 104 positioned on opposing sides of the mold 102 and configured to apply a pressure to the base material 106 in the cavity 108 defined in the mold 102 and between the two rams 104. In an EFAS assembly, a voltage is applied between the two rams 104 to induce an electric current from the first ram 104, through the mold 102 and the materials in the cavity 108, and out the second ram 104. The electrical current passing through the mold 102 and the base material 106 in the cavity 108 generates heat in the mold 102 and the base material 106 in the cavity 108 based on the resistance of the material of the mold 102 and the base material 106 in the cavity 108 to the electrical current.

In a conventional sintering process, a base material to be sintered is disposed in a cavity of a mold in a powdered or granulated form. A pressure is then applied to the cavity, such as through rams and a temperature of the mold that defines the cavity is raised to a sintering temperature of the base material within the cavity. The sintering temperature is less than the melting temperature of the base material but is sufficiently high that the individual particles in the powdered or granulated material fuse together under pressure to form a solid structure.

In the embodiment illustrated in FIG. 1, the sintering assembly 100 includes a positive punch 112 and a negative punch 114 disposed in the cavity 108 between the rams 104. The positive punch 112 and the negative punch 114 may combine to define a complex shape (e.g., a complex geometry) in the cavity 108 between the positive punch 112 and the negative punch 114. The base material 106 may be disposed between the positive punch 112 and the negative punch 114, such that after the sintering process the base material 106 forms a sintered structure (e.g., a sintered article) having substantially the same complex shape as the complex shape defined between the positive punch 112 and the negative punch 114.

The positive punch 112 and the negative punch 114 may be formed from a material having a high hardness and a large thermal resistance. The positive punch 112 and the negative punch 114 may be formed from a similar material as the mold 102 and the rams 104. For example, the positive punch 112 and the negative punch 114 may be formed from one or more of graphite, carbon-carbon, and tungsten carbide.

The positive punch 112 and the negative punch 114 may each include a ram interface 116. The ram interface 116 may be a substantially flat surface of the positive punch 112 and the negative punch 114 that is configured to interface with a corresponding substantially flat surface of the rams 104. In some embodiments, at least one of the positive punch 112 and the negative punch 114 are configured to rest against the surface of the rams 104 at the ram interface 116 without being attached to the rams 104. In other embodiments, one or more of the positive punch 112 and the negative punch 114 may be secured to the rams 104, such as through a hardware connection (e.g., bolt, screw, stud, etc.).

The positive punch 112 and the negative punch 114 may be formed from one or more segments 118. The segments 118 may each be individual separate pieces, as described in further detail below. The segments 118 may combine to form the positive punch 112 and the negative punch 114 and to define the complex shape between the positive punch 112 and the negative punch 114. In some embodiments, one segment of one of the positive punch 112 and the negative punch 114 may be secured to the associated ram 104 while the other segments 118 are not attached to the associated rams 104.

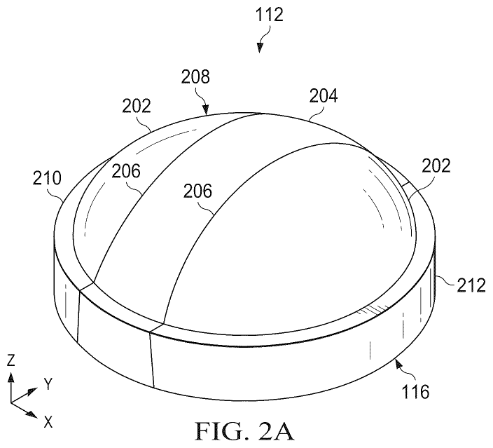

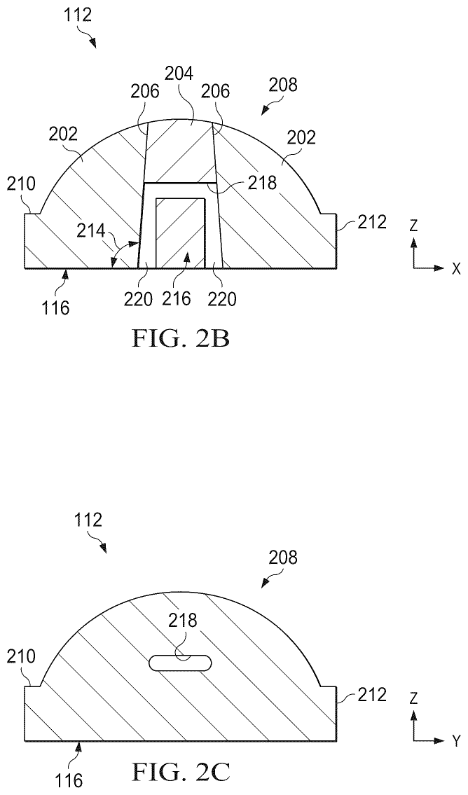

FIGS. 2A-2C illustrate views of the positive punch 112 of the sintering assembly 100. The positive punch 112 may be formed from multiple segments, such as two (2) segments, three (3) segments, four (4) segments, five (5) segments or more. The positive punch 112 illustrated in FIGS. 2A-2C is formed from two outer segments 202 and an inner segment 204. The inner segment 204 is positioned between the two outer segments 202 to form a dome 208 (e.g., semispherical geometry). The outer segments 202 and the inner segment 204 include interfaces 206 configured to position the inner segment 204 relative to the outer segments 202 to form a substantially constant surface of a dome 208 and a substantially flat ram interface 116.

The interfaces 206 may be angled, such that when the ram interface 116 of the outer segments 202 and the inner segment 204 are substantially aligned, a surface of the dome 208 is substantially smooth or constant. The angle of the interfaces 206 may be configured to facilitate the removal of the inner segment 204 of the positive punch 112 in a direction toward the ram interface 116. In other words, the inner segment 204 may be removable. For example, the inner segment 204 may have a greater width at the ram interface 116 than the width of the inner segment 204 at the dome 208. The interfaces 206 may also include one or more alignment features. For example, the interfaces 206 may include complementary grooves or ridges configured to align the inner segment 204 and the outer segments 202. The alignment features may extend in a direction between the ram interface 116 and the dome 208 of the positive punch 112 to maintain a desired orientation of the inner segment 204 relative to the outer segments 202.

The positive punch 112 may also include a shoulder 210 on a radial outer portion of the positive punch 112 between the dome 208 and an outer surface 212 of the positive punch 112. The outer surface 212 may be configured to interface with the mold 102 (FIG. 1). For example, the mold 102 (FIG. 1) may have a substantially cylindrical shape defining the cavity 108 (FIG. 1) with a major dimension (e.g., radius, diameter, width, apothem, etc.) that is complementary to a major dimension of the rams 104 (FIG. 1). The outer surface 212 of the positive punch 112 may also define a major dimension that is complementary to the major dimension of the cavity 108 (FIG. 1), such that the assembled positive punch 112 extends laterally (e.g., in an XY plane) across the cavity 108 (FIG. 1) substantially filling the cavity 108 (FIG. 1) laterally in the region associated with the outer surface 212. The shoulder 210 and the outer surface 212 may be configured to maintain the base material 106 (FIG. 1) on the dome 208 side of the positive punch 112 when pressure is applied to the positive punch 112 by the ram 104 (FIG. 1) through the ram interface 116.

FIGS. 2B and 2C illustrate cross-sections of the positive punch 112. FIG. 2B illustrates a vertical cross-section of the positive punch 112 along the X-axis and FIG. 2C illustrates a vertical cross-section of the positive punch 112 along the Y-axis. As discussed above, the outer segments 202 abut against the inner segment 204 along interfaces 206. The interfaces 206 may define an angle 214 relative to the ram interface 116 when the rams 104 apply pressure to the base material 106. The angle 214 may be greater than about 90°, such as in a range from about 91° to about 135°, such as from about 93° to about 100°.

After the pressure applied by the rams 104 (FIG. 1) is released, the angle 214 may facilitate the removal of the inner segment 204 in a direction toward the ram interface 116. Removing the inner segment 204 may release lateral pressures (e.g., in the X-direction) applied by the inner segment 204 onto the outer segments 202. Releasing the lateral pressures may also facilitate the removal of the outer segments 202 after the removal of the inner segment 204.

The inner segment 204 may include a removal structure 216 configured to facilitate applying a vertical force (e.g., in the Z-direction) toward the ram interface 116. For example, the removal structure 216 may be a structure configured to facilitate gripping the inner segment 204, such as a hook, groove, internal passage, threaded hole, etc. The removal structure 216 may also provide a structure configured to facilitate gripping the inner segment 204 through the otherwise flat surface of the ram interface 116.

In the embodiment illustrated in FIGS. 2B and 2C, the removal structure 216 includes a channel 218 configured to receive an external component, such as a strap, rope, wire, cord, hook, etc., through passages 220 on either side of the channel 218 that extend to the ram interface 116. Thus, the external component may pass through the passages 220 and the channel 218. An axial force may then be applied to the external component, pulling the inner segment 204 axially out of the positive punch 112 in a direction parallel with the axis 110 (FIG. 1). This may facilitate removing the inner segment 204 after a high pressure, high temperature sintering operation where the inner segment 204 and the outer segments 202 may adhere (e.g., stick together) due to the high pressures and high temperatures.

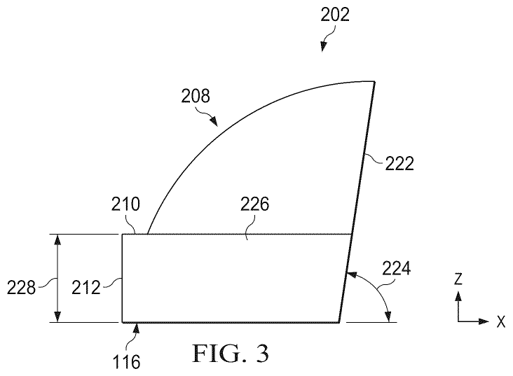

FIG. 3 illustrates a cross-sectional view of an outer segment 202 of the positive punch 112. The outer segment 202 forms a portion of the dome 208 and includes a portion of the shoulder 210 and a portion of the outer surface 212. The outer segment 202 also includes an interface surface 222 forming a radially inner surface of the outer segment 202. The interface surface 222 may form the outer segment 202 side of the interface 206 (FIGS. 2A and 2B) between the outer segment 202 and the inner segment 204 (FIGS. 2A and 2B) discussed above.

The interface surface 222 may define an angle 224 relative to the ram interface 116. The angle 224 may be a supplemental angle to the angle 214 (FIG. 2B) of the interface 206 (FIG. 2B) relative to the ram interface 116. For example, the angle 224 may be in a range from about 45° to about 89°, such as in a range from about 80° to about 87°.

The outer segment 202 may include a base 226 configured to structurally support the outer segment 202 when a pressure is applied to the ram interface 116 by the rams 104 (FIG. 1). The base 226 may be defined between the ram interface 116 and the shoulder 210. The outer surface 212 of the outer segment 202 that extends to the mold 102 (FIG. 1) may be the radially outer surface of the base 226. The base 226 may define a thickness 228 sufficient to transfer the pressure applied by the rams 104 (FIG. 1) to the dome 208 without damaging the base 226. For example, the thickness 228 of the base 226 may be in a range from about ¼ of a total height (e.g., in the Z-direction) of the positive punch 112 to about ½ of the total height of the positive punch 112.

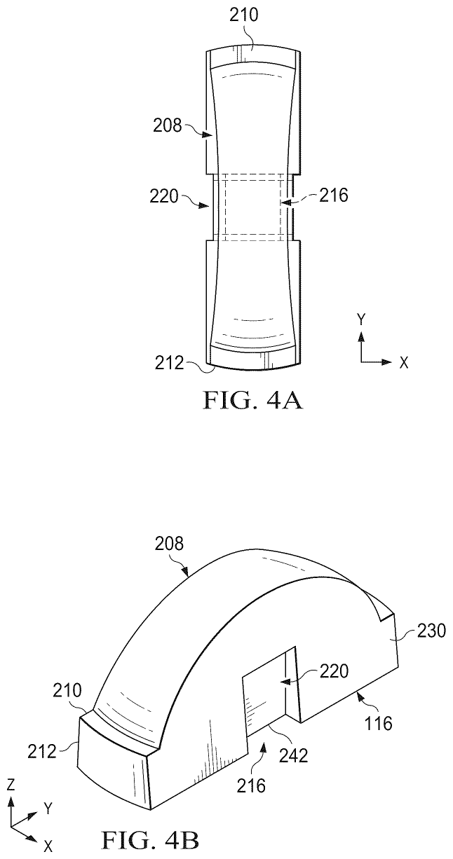

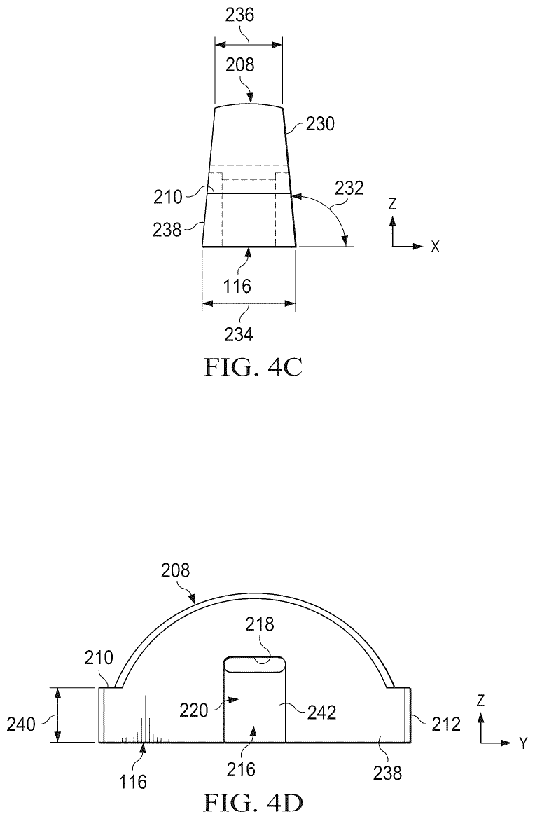

FIGS. 4A-4D illustrate different views of the inner segment 204 of the positive punch 112. The inner segment 204 forms a portion of the dome 208 and includes a portion of the shoulder 210 and a portion of the outer surface 212. The length or area of the portions of the shoulder 210 and the outer surface 212 of the inner segment 204 may be less than the length or area of the portions of the shoulder 210 and the outer surface 212 included on the outer segments 202. The inner segment 204 also includes interface surfaces 230 forming laterally outer surfaces of the inner segment 204. The interface surfaces 230 may form the inner segment 204 side of the interfaces 206 (FIGS. 2A and 2B) between the outer segments 202 and the inner segment 204 (FIGS. 2A and 2B) discussed above.

The interface surfaces 230 may each define an angle 232 relative to the ram interface 116. The angle 232 may be a supplemental angle to the angle 224 (FIG. 3) of the interface surfaces 222 (FIG. 3) of the outer segments 202 (FIGS. 2A-3) and substantially the same as the angle 214 (FIG. 2B) of the interface 206 (FIG. 2B) relative to the ram interface 116, such that the interface surfaces 230 are complementary to the interface surfaces 222 (FIG. 3) of the outer segments 202 (FIGS. 2A-3). For example, the angle 232 may be greater than 90°, such as in a range from about 91° to about 135°, such as in a range from about 93° to about 100°. The angles 232 of the interface surfaces 230 may result in a width 234 of the inner segment 204 proximate the ram interface 116 being greater than a width 236 of the inner segment 204 proximate the dome 208. As illustrated in FIGS. 4A-4C, the lateral width 234 (e.g., in the X-direction) of the inner segment 204 between the interface surfaces 230 in a region proximate the ram interface 116 is greater than the lateral width 236 (e.g., in the X-direction) of the inner segment 204 between the interface surfaces 230 in a region proximate the dome 208.

The inner segment 204 may include a base 238 configured to structurally support the inner segment 204 when a pressure is applied to the ram interface 116 by the rams 104 (FIG. 1). The base 238 may be defined between the ram interface 116 and the shoulder 210. The outer surface 212 of the inner segment 204 that extends to the mold 102 (FIG. 1) may be the radially outer surface of the base 226 in a longitudinal direction (e.g., Y-direction). The base 238 may define a thickness 240 that is substantially the same as the thickness 228 (FIG. 3) of the base 226 (FIG. 3) of the outer segment 202 (FIGS. 2A-3). The thickness 240 of the base 238 may be sufficient to transfer the pressure applied by the rams 104 (FIG. 1) to the dome 208 without damaging the base 238. For example, the thickness 240 of the base 238 may be in a range from about 1/4 of a total height (e.g., in the Z-direction) of the positive punch 112 to about 1/2 of the total height of the positive punch 112.

As discussed above, the inner segment 204 may include a removal structure 216 configured to facilitate the removal of the inner segment 204 from between the outer segments 202 (FIGS. 2A-3) after forming the associated structure. In the embodiment illustrated in FIGS. 4A-4D, the removal structure 216 includes two passages 220 defined in the interface surfaces 230 of the inner segment 204. The passages 220 are arranged on opposing lateral sides (e.g., in the X-direction) of the inner segment 204. The passages 220 define recesses in the interface surfaces 230. The recesses or passages 220 extend to the channel 218 defined through the inner segment 204. The channel 218 connects the two opposing passages 220 through the interior portion of the inner segment 204.

The channel 218 and the two opposing passages 220 may define a bridge 242 in the inner segment 204. The bridge 242 may be configured to connect the material of the inner segment 204 on opposite longitudinal sides (e.g., in the Y-direction) of the two opposing passages 220 and to form a bottom surface of the channel 218. In some embodiments, the inner segment 204 is removed by gripping the bridge 242 with external tooling, such as clamps, pliers, wrenches, etc., and applying an axial force to the inner segment 204 through the bridge 242. In other embodiments, the inner segment 204 is removed by passing an element, such as a strap, cord, hook, or other tooling, at least partially through the channel 218 and applying an axial force to the bridge 242 through the channel 218.

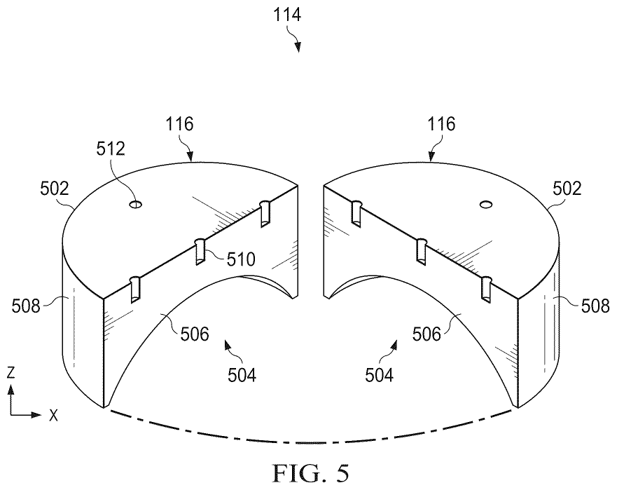

FIG. 5 illustrates an exploded perspective view of the negative punch 114 of the sintering assembly 100 illustrated in FIG. 1. The negative punch 114 may be formed from at least two segments 502. In the embodiment illustrated in FIG. 5, the negative punch 114 is formed from two segments 502. In other embodiments, the negative punch 114 may be formed from additional segments 502, such as three segments 502, four segments 502, etc. For example, the negative punch 114 may include an intermediate segment 502 and two outer segments 502, similar to the positive punch 112 (FIGS. 2A-2C) discussed above.

The segments 502 of the negative punch 114 each define a cavity 504. When the segments 502 are assembled to form the negative punch 114, the cavity 504 may be substantially complementary to the dome 208 (FIGS. 2A-2C) of the positive punch 112 (FIGS. 2A-2C). Thus, a structure formed between the negative punch 114 and the positive punch 112 may have a thickness that is substantially constant throughout the space defined between the negative punch 114 and the positive punch 112 (FIG. 1) within the cavity 108 (FIG. 1) of the mold 102 (FIG. 1). In some embodiments, the cavity 504 defined by the negative punch 114 has a different shape from the shape of the dome 208 (FIGS. 2A-2C), such that the thickness of the structure formed between the negative punch 114 and the positive punch 112 (FIG. 1) has a variable thickness throughout the space defined between the negative punch 114 and the positive punch 112 (FIG. 1) within the cavity 108 (FIG. 1) of the mold 102 (FIG. 1).

The segments 502 of the negative punch 114 each include an interface surface 506. The interface surface 506 may be substantially planar and complementary, such that, when assembled, the segments 502 of the negative punch 114 joint together at the interface surfaces 506 and are configured to maintain the base material 106 (FIG. 1) within the cavity 504 defined by the negative punch 114. In the embodiment illustrated in FIG. 5, the interface surfaces 506 are substantially parallel with the vertical axis (e.g., Z-axis) of the negative punch 114.

The segments 502 of the negative punch 114 each also include an outer surface 508. When assembled as the negative punch 114, the outer surfaces 508 of the segments 502 combine to form a radially outer surface of the negative punch 114. The outer surfaces 508 may have substantially the same shape as the combined outer surfaces 212 of the segments 202, 204 of the positive punch 112 (FIGS. 2A-4D). The outer surfaces 508 may have a complementary shape and size to the cavity 108 (FIG. 1) defined by the mold 102 (FIG. 1).

The segments 502 of the negative punch 114 may include one or more locating structures configured to align and maintain an orientation between the segments 502 of the negative punch 114 when assembled. For example, the segments 502 may include complementary ridges and recesses in the interface surfaces 506 configured to maintain an orientation between the segments 502 of the negative punch 114. In other embodiments, the segments 502 may include features configured to receive external components to maintain the orientation between the segments 502. In the embodiment illustrated in FIG. 5, the segments 502 each include an aperture 512 defined in the ram interface 116 of the segments 502. The apertures 512 may be configured to receive an external alignment structure, such as a pin, to maintain the orientation of the segments 502. For example, a bracket or bridge including two pins may span across the two segments 502 and the pins may be inserted into the apertures 512 to secure the segments 502 radially to one another. In another embodiment, the rams 104 (FIG. 1) may include pins configured to interface with the apertures 512 to secure the segments 502 radially relative to the rams 104 (FIG. 1).

The segments 502 illustrated in FIG. 5 also include recesses 510 defined in the interface surface 506 proximate the ram interface 116. The recesses 510 may be configured to receive complementary structures or hardware configured to radially secure the segments 502 relative to one another. In another embodiment, the interface surface 506 of one segment 502 may include the recesses 510 and the interface surface 506 of a second segment 502 may include complementary protrusions (not shown) configured to interface with the recesses 510 of the first segment 502. In some embodiments, the recesses 510 may be configured to receive external tooling to facilitate assembly or disassembly of the negative punch 114. For example, a prying tool (e.g., pry bar, screw driver, punch, etc.) may be inserted into the recesses 510 to apply a radial force between the two segments 502 to release the segments 502 from a structure after the sintering process.

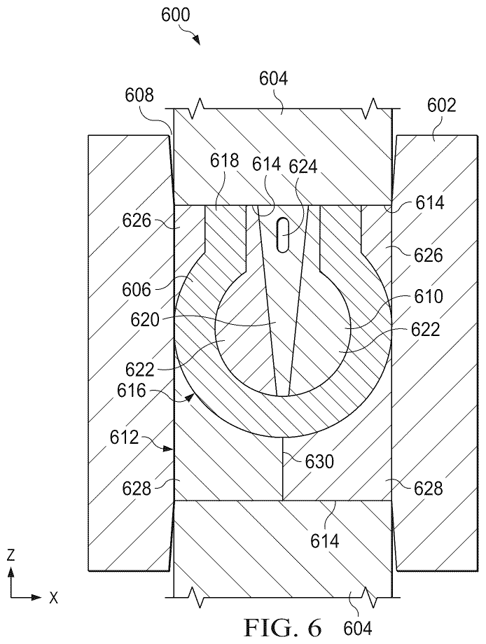

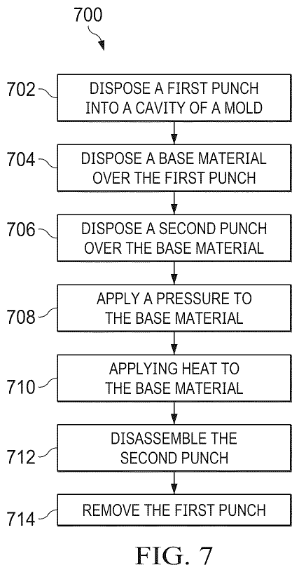

FIG. 6 illustrates an embodiment of a sintering assembly 600 that may be used to form a structure through a sintering process. The sintering assembly 600 may be configured to heat a base material 606 while applying a pressure to the base material 606 to form a solid structure. In some embodiments, the sintering assembly 600 is an electric field assist sintering (EFAS) assembly configured to apply a pressure to the base material 606 while heating the base material 606 and sintering assembly 600 by passing an electric current through the sintering assembly 600 and the base material 606. In other embodiments, the sintering assembly 600 may be a hot press sintering assembly where the sintering assembly 600 is heated externally, such as through inductive heating, resistance heating, etc.

The sintering assembly 600 includes a mold 602 defining a cavity 608 within the mold 602 configured to receive the base material 606 to be sintered. The sintering assembly 600 also includes one or more rams 604 configured to apply pressure to the base material 606 in the cavity 608 of the mold 602. In the embodiment illustrated in FIG. 6, the sintering assembly 600 includes two opposing rams 604 positioned on opposing sides of the mold 602 and configured to apply a pressure to the base material 606 in the cavity 608 defined in the mold 602 and between the two rams 604.

In the embodiment illustrated in FIG. 6, the sintering assembly 600 includes a positive punch 610 and a negative punch 612 disposed in the cavity 608 between the rams 604. The positive punch 610 and the negative punch 612, in combination, define a complex shape (e.g., a complex geometry) in the cavity 608 between the positive punch 610 and the negative punch 612. The base material 606 may be disposed between the positive punch 610 and the negative punch 612, such that after the sintering process, the base material 606 forms a sintered structure (e.g., a sintered article) having substantially the same complex shape as the complex shape defined between the positive punch 610 and the negative punch 612.

The positive punch 610 and the negative punch 612 may be formed from a material having a high hardness and a large thermal resistance. The positive punch 610 and the negative punch 612 may be formed from a similar material as the mold 602 and the rams 604. For example, the positive punch 610 and the negative punch 612 may be formed from one or more of graphite, carbon-carbon, and tungsten carbide.

The positive punch 610 and the negative punch 612 may each include a ram interface 614. The ram interface 614 may be a substantially flat surface of the positive punch 610 and the negative punch 612 that is configured to interface with a corresponding substantially flat surface of the rams 604. In some embodiments, at least one of the positive punch 610 and the negative punch 612 are configured to rest against the surface of the rams 604 at the ram interface 614 without being attached to the rams 604. In other embodiments, one or more of the positive punch 610 and the negative punch 612 may be secured to the rams 604, such as through a hardware connection (e.g., bolt, screw, stud, etc.).

The positive punch 610 and the negative punch 612 may be formed from one or more segments. The segments may each be individual separate pieces, as described in further detail below. The segments may combine to form the positive punch 610 and the negative punch 612 and to define the complex shape between the positive punch 610 and the negative punch 612. In the embodiment illustrated in FIG. 6, the complex shape of the sintered structure includes a spherical portion 616 (e.g., semi-spherical portion) and a stem portion 618, where the stem portion 618 has a major dimension (e.g., diameter, radius, apothem, etc.) that is smaller than a major dimension of the spherical portion 616.

In the embodiment illustrated in FIG. 6, the positive punch 610 is formed from multiple different segments 620, 622. The positive punch 610 includes an inner segment 620 and multiple outer segments 622. For example, the inner segment 620 may have a three-dimensional triangular shape, such as a conical shape, a pyramid shape, or a frustrum shape. The positive punch 610 may include at least three outer segments 622 configured to form the inner wall of the spherical portion 616. The inner segment 620 may include a removal structure 624 configured to receive an external element. The removal structure 624 may be used to apply an axial force to the inner segment 620 once the sintering process is completed to remove the inner segment 620. Once the inner segment 620 is removed, the outer segments 622 may be removed one by one through the space in the stem 618. The number of outer segments 622 included in the positive punch 610 may be selected, such that each individual outer segment 622 is sized to be removed through the opening defined in the stem 618.

The negative punch 612 may include multiple different segments 626, 628. In the embodiment illustrated in FIG. 6, the negative punch 612 includes an upper segment 626 and a lower segment 628. The upper segment 626 and the lower segment 628 may each include multiple segments as well. For example, the upper segment 626 and the lower segment 628 may each be separated into at least two segments along a separation line 630. In some embodiments, one of the upper segment 626 and the lower segment 628 may be formed from a single structure. For example, the upper segment 626 may be an annular structure without any separation regions, such that the upper segment 626 is a single annular structure. The lower segments 628 may be formed similar to the segments 502 of the negative punch 114 illustrated in FIG. 5.

The upper segment 626 of the negative punch 612 may have a ram interface 614 that is coplanar with the ram interface 614 of the positive punch 610. The substantially flat surface of the ram 604 may be configured to maintain an axial positional relationship between the upper segment 626 of the negative punch 612 and the positive punch 610 through the respective ram interfaces 614.

FIG. 7 illustrates a flow chart representative of a method 700 of sintering a structure. The method includes disposing a first punch defining a negative shape or cavity into a mold in act 702. The mold may define a substantially cylindrical cavity. In some embodiments, the mold may include a base defining a bottom of the mold, such that the first punch defining the negative shape rests on the bottom of the mold. In other embodiments, the mold may be open on both axial ends and configured to receive a ram through the openings on each axial end. Thus, the first punch defining the negative shape may rest on a surface of a ram.

After disposing the first punch defining the negative shape into the mold, a base material may be disposed (e.g., deposited) into the mold and over the first punch defining the negative shape in act 704. The base material may substantially fill the negative shape or cavity defined by the first punch. The base material may be a particulate or powdered material formed from many small particles of the base material. For example, the base material may be particles of metal materials (e.g., tungsten, molybdenum, iron, carbon, cobalt, nickel, bronze, copper, etc.) or ceramic base materials (e.g., silica, alumina, zirconia, silicon carbide, boron nitride, etc.).

After disposing the base material into the cavity or negative shape of the first punch, a second punch defining a positive shape may be disposed into the mold over the base material in act 706. The positive shape defined by the second punch may be complementary to the negative shape defined by the first punch. The base material may be sandwiched between the first punch and the second punch, such that the base material substantially fills the space between the first punch and the second punch. Because the base material is a powder or particulate, the base material may substantially conform to the shape defined between the first punch and the second punch.

A pressure may be applied to the base material between the first punch and the second punch in act 708. The pressure may be applied axially by one or more rams extending into the cavity of the mold. For example, in an embodiment where the mold includes a base and one open end, a ram may apply pressure to the second punch in a direction toward the base of the mold, compressing the base material between the first punch and the second punch. In another embodiment where the mold is open on both axial ends, two rams may extend axially into the cavity of the mold, applying axial pressure to both the first punch and the second punch and compressing the base material between the first punch and the second punch.

While the pressure is being applied to the base material, the base material may also be heated in act 710. The heat applied to the base material may raise the temperature of the base material to a sintering temperature. As discussed above, the sintering temperature may be a temperature that is less than a melting temperature of the base material that is configured to cause the pressurized particles of the base material to fuse together. The heat may be applied through an external source, such as a furnace, an inductive heater, or a resistive heater. In other embodiments, the heat may be applied through an electrical current passing through the mold, directly heating the mold, the base material, and the other components disposed in the mold through the resistance of the respective materials to the electrical current.

The base material may be maintained under pressure at the elevated temperature for a time period until the base material is sintered into a solid structure. After the base material forms the solid structure, the pressure may be released and the heat removed. After removing the pressure and the heat, the second punch defining the positive shape may be disassembled in act 712. The second punch may be removed by disassembling the second punch. The second punch may be disassembled by removing an intermediate segment of the second punch. The intermediate segment may have angled sides, such that the portion of the intermediate segment proximate the solid sintered structure has a width that is less than a width of the intermediate segment where the pressure was applied by the ram. The intermediate segment may be removed by applying an axial force on the intermediate segment away from the solid sintered structure. As discussed above, the intermediate segment may include a removal structure configured to interface with a tool or other external device for applying the axial force. Once the intermediate segment is removed, the other segments of the second punch may be removed by moving the other segments radially inward into the space vacated by the intermediate segment and then removing the other segments axially from the solid sintered structure. By removing the segments of the punches sequentially, minimal damage may occur to the sintered structure or to the first and second punches. Without being bound by any theory, binding stresses and interface bonding between the material of the sintered structure and the segments of the first punch and the second punch are believed to be reduced, which enables the sintered structure to be easily removed and recovered.

After the base material forms the solid structure, the first punch defining the negative shape may also be removed from around the solid sintered structure in act 714. In some embodiments, the first punch may include segments. The segments may be separated, releasing the solid sintered structure from the cavity or negative shape of the first punch. In some embodiments, the first punch may include recesses defined between the segments of the first punch and the segments of the first punch may be separated by applying a lateral or radial force between the segments through the recesses, such as through a prying tool.

The embodiments of the disclosure may facilitate the formation of sintered structures having complex geometries. Many materials formed through conventional sintering processes are hard materials that are difficult or impossible to machine. Forming sintered structures according to embodiments of the disclosure and having complex geometries may facilitate the use of harder materials in applications where complex geometric features are used. Sintering structures having complex geometries may also reduce the costs of producing the sintered structures having complex geometries from harder materials, such as by reducing machining costs. The sintered structures may also be easily and reliably removed from punches used to form the sintered structures since the punches may be disassembled after conducting the sintering process. The sintered structures may be removed without damaging the punches or the sintered structures. The sintered structures may also exhibit a decreased likelihood of material failure due to the reduced damage. In addition, the punches may be reused. The sintered structures may, for example, be used in extreme environments, such as in components for nuclear reactors.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A sintering assembly comprising:
a mold defining a cavity;
at least one ram configured to extend into the cavity;
a negative punch disposed in the cavity; and
a positive punch disposed in the cavity, the positive punch comprising at least two segments, each segment of the at least two segments comprising a ram interface configured to abut against the at least one ram.

2. The sintering assembly of claim 1, wherein the at least two segments define an interface between the at least two segments.

3. The sintering assembly of claim 2, wherein the interface defines an angle between the interface and the ram interface that is greater than about 90°.

4. The sintering assembly of claim 3, wherein the angle is in a range from about 91° to about 135°.

5. The sintering assembly of claim 1, wherein at least one segment of the at least two segments of the positive punch comprises a removal structure configured to facilitate gripping the at least one segment and applying an axial force toward the ram interface.

6. The sintering assembly of claim 5, wherein the removal structure comprises one or more of a hook, a groove, an internal passage, or a threaded hole.

7. The sintering assembly of claim 1, wherein the at least two segments of the positive punch comprise an inner segment and at least two outer segments.

8. The sintering assembly of claim 7, wherein the inner segment has a first width proximate the ram interface and a second width opposite the ram interface, the second width less than the first width.

9. The sintering assembly of claim 7, wherein the inner segment has a three-dimensional triangular shape.

10. A method comprising:
disposing a first punch into a cavity of a mold, the first punch comprising one or more segments;
depositing a base material over the first punch in the cavity of the mold;
disposing a second punch over the base material in the cavity of the mold, the second punch comprising one or more segments;
applying a pressure to the base material between the first punch and the second punch;
applying heat to the base material between the first punch and the second punch until the base material forms a solid structure;
removing the first punch from the solid structure by separating one segment of the first punch from another segment of the first punch; and
removing the second punch from the solid structure by separating a first segment of the second punch from a second segment of the second punch.

11. The method of claim 10, wherein disposing the second punch over the base material in the cavity of the mold comprises disposing the second punch defining a positive shape into the cavity of the mold, the positive shape complementary to a negative shape defined by the first punch.

12. The method of claim 10, wherein removing the second punch from the solid structure by separating the first segment of the second punch from the second segment of the second punch comprises removing an intermediate segment of the second punch from between at least two outer segments of the second punch.

13. The method of claim 12, wherein removing the intermediate segment of the second punch comprises moving the intermediate segment axially away from the solid structure.

14. The method of claim 12, wherein removing the intermediate segment of the second punch comprises gripping a removal structure with an external device and applying an axial force to the intermediate segment.

15. The method of claim 14, wherein gripping the removal structure with the external device comprises gripping the removal structure with one or more of a strap, a rope, a wire, a cord, or a hook.

16. A sintering punch comprising:
a base;
a semispherical surface on an opposite axial end of the sintering punch from the base;
an intermediate segment forming an intermediate portion of the base and an intermediate portion of the semispherical surface;
at least two outer segments forming outer portions of the base and outer portions of the semispherical surface, the intermediate segment configured to be removed axially relative to the at least two outer segments; and
an interface between the intermediate segment and at least one of the at least two outer segments, the interface angled such that the intermediate segment has a first width at the base that is greater than a second width of the intermediate segment at the semispherical surface.

17. The sintering punch of claim 16, wherein the intermediate segment and the at least two outer segments comprise one or more of graphite, carbon-carbon, and tungsten carbide.

18. The sintering punch of claim 16, wherein the intermediate segment comprises a removal structure configured to facilitate gripping the intermediate segment and applying an axial force toward the base.

19. The sintering punch of claim 16, wherein the intermediate segment has a three-dimensional triangular shape.

20. The sintering punch of claim 16, wherein the interface between the intermediate segment and at least one of the at least two outer segments comprises one or more alignment features.
